(19) United States
(12) Patent Application Publication
(10) Pub. No.: US 2007/0220426 A1
(43) Pub. Date: Sep. 20, 2007

(54) Method and System to Provide a Certified Lexicon for Document Drafting

(75) Inventors: Raymond J. Mueller, Palm Beach Gardens, FL (US); Andrew S. Van Luchene, Santa Fe, NM (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/697,468

(22) Filed: Apr. 6, 2007

Related U.S. Application Data
(63) Continuation-in-part of application No. 11/462,621, filed on Aug. 4, 2006.
(60) Provisional application No. 60/727,191, filed on Oct. 14, 2005.

(51) Int. Cl. G06F 17/00; G06F 15/00

(52) U.S. Cl. 715/532; 715/513; 715/500; 715/531

(57) ABSTRACT

The disclosure provides a lexicon tool including a database that includes a plurality of terms which may be words, phrases, paragraphs, documents, photographs, etc, and at least one definition for each term. Each definition is associated with a subject matter identifier that aids in determining how the definitions are presented to an end user.

### CROSS REFERENCE TO RELATED APPLICATIONS

The present application is a continuation in part of U.S. patent application Ser. No. 11/462,621, “Fee-Based Priority Queuing for Insurance Claim Processing” filed Aug. 4, 2006, which claims the benefit of U.S. Provisional Patent Application No. 60/727,191, filed Oct. 14, 2005, each of which is hereby incorporated by reference.

### BACKGROUND OF THE INVENTION

Protecting intellectual property through patent systems is a vital part of most countries' national economies and well as the global economy. However, many patent systems are facing a number of challenges due to the increased technical complexity of patent applications as well as with the challenge of hiring and training new patent examiners to cope with the increasing number of applications being filed.

In 2000, 311,807 patent applications were filed in the U.S. This number increased to 409,532 applications in 2005. Globally, 145,300 applications were filed under the Patent Cooperation Treaty in 2006, representing a 6.4% growth over the previous year. This trend has held steady since 1995 with the number of applications filed increasing every year.

The problems in the protection of intellectual property rights are further compounded by virtual reality games. Hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. Many of these games purport to give intellectual property rights to the players in their virtual creations. However, these games lack a structured system for evaluating and granting such rights.

Given the increasing number of applications being filed and the increased demand for protection of intellectual property, it would be advantageous to provide alternate methods for assigning and distributing applications for examinations. Such alternate methods would relieve some of the pressure on patent systems, allowing examiner's to focus on the aspects of their duties that require human involvement.

### DETAILED DESCRIPTION

According to various embodiments, the present disclosure provides methods and systems to provide a living lexicon for document drafting. In one embodiment, a database of words with definitions and associated images is provided in a lexicon tool for drafting documents, such as, for example, patent applications. In some embodiments, word definition may be associated with one or more patent classes, subclasses, or general areas of interest, so that a definition that is appropriate for the subject matter in the document being drafted could more readily be presented to the user.

According to various embodiments, additional definitions for existing words can also be added to a word record. In some embodiments, some or all additions and changes to the lexicon are placed in one or more queues for approval. When a word addition or change has been approved, the word may be made available in a patent application drafting tool for use. Definitions may also be imported from or otherwise provided by and/or linked to or with one or more existing dictionaries and other resources, such as Webster's Dictionary, Wikipedia or Google's online dictionaries.

According to some embodiments, definitions of words and/or the association of definitions with classes, subclasses, or general areas of interest can be entered into the database by end users, who may or may not be required to have been authorized to perform such functions. In this manner, definitions can be updated in real time as words and language evolve and as patent drafters act as lexicographers to more precisely define disclosed inventions.

In some embodiments, the lexicon tool described herein may be used in conjunction with a Patent Drafting Tool (PDT). A PDT may take the form of a web-based patent application drafting and submission tool such as that described in U.S. patent application Ser. No. 11/627,263 “Automated Web-Based Application Preparation and Submission” filed Jan. 25, 2007, which is incorporated herein by reference. A PDT may further provide for mechanisms for performing prior art searches or other patent drafting and examination-related activities.

According to some embodiments, applicants, attorneys, examiners, or other entities, (collectively, “end users”), who may or may not have to be authorized, may prepare or access a patent application via the PDT and indicate the class and subclass of the (intended) subject matter in the application. Alternatively, the end user may simply indicate a general area of interest, such as by entering one or more keywords, sample paragraphs, sample claims, etc. The lexicon tool can then identify those worlds in its database that provide definitions that are associated with the indicated class, subclass, or general area of interest. A lexicon of words with corresponding definitions may then be presented. Accordingly end users can use the words provided by the lexicon tool in drafting, or subsequently modifying, an application.

For example, the word “shaft” may have a first definition of “a long, comparatively straight handle serving as an important or balancing part of an implement or device” and a second definition of “A long, narrow, often vertical passage sunk into the earth, as for mining ore; a tunnel.” The first definition might be associated with class 463 (amusement devices: games) and the second definition might be associated with class 175 (boring or penetrating the earth). Accordingly, a practitioner preparing a patent application for a golf club might preferentially be shown the first definition over the second definition, since a golf club would be more readily classified as an amusement device than as something that penetrates the earth.

According to various embodiments:

Advertisement—includes any communication via any medium to any one or more end users or any person or third party. Advertisements may include text, audio, video, icons, graphics, images, etc. Advertisements may include an offer for sale, for profit or not, and may or may not include a discount, for any services, products, financial instruments, e.g., insurance, annuities, securities, e.g., stocks, bonds, options, etc. and/or any other good or service, and/or may provide information about any of the forgoing or anything, such as a request for donations to political or charitable or any other entity or organization. Or, an advertisement might be used or designed to provide information to inform or educate any constituent and/or may include communications in support of any one or more objectives such as public relations, publicity, product placement or introduction, sponsorship, underwriting, public notice or service announcement or any other objective or purpose.

Alert—includes the transfer, delivery or storage of information or otherwise communicating with, by, between or among any two or more of the following, including, but not limited to any real or virtual: a) end user, b) game owners, c) game or other servers, d) player or player characters, e) NPC's, f) exchanges, g) game devices or controllers, h) cell phone or other communications hardware and/or networks, i) databases, j) software applications, k) legal agencies, l) governing bodies, m) software interfaces, n) any person, o) and/or any combination of any of the above, which may be initiated by and/or based upon an alert event or other action. An exemplary system and method for sending alerts is described in U.S. patent application Ser. No. 11/676,848, which is hereby incorporated by reference.

Alert Event—includes any change in, of or to any condition or state, and includes any action, opposite action, unexpected action, desire for action, or failure to act, and thus Alert Event includes, but is not limited to any one or more of:
1. When or after any one or more variables or data changes or is expected or is about to change within an application, service, API, communications network or one or more databases, or database variables or element, e.g., a balance is reached or exceeded
2. When an end-user acts, e.g., clicks on a word or link, or fails to act as or when expected.
3. An amount of time elapses with or without an action.
4. When or after information is transmitted and/or shared (e.g. via a communications package or other mechanism) between two or more applications, services, servers, financial institutions, or any other entities, e.g., a message sent between two servers to provide information about one or more hyperlinks.

Approval Queue—includes a queue of documents and or prior art associated with those documents that is awaiting an approval mark from an entity such as a patent examiner

Boilerplate—includes any text, word, words, or phrases and/or part or all of a document which may be readily or otherwise reused with little or no modification and/or to serve as the basis of a new phrase or document, which use may save time and effort in the creation of said phrase or document. Boilerplate may include standard documents, terms, conditions, words, phases, etc., that can be incorporated or reused in multiple applications.

Blog—includes a user-generated website or other system where entries may be made in journal or other style and may be displayed in a reverse chronological or other order. Blogs often provide commentary or news on a particular subject, such as food, politics, or local news; some function as more personal online diaries. Blogs may include and/or combine or use text, images, and may include links, including hyperlinks to other blogs, web pages, documents, words, and other media related to its topic or subject matter. The term “blog” is derived from the term “Web log.” “Blog” can also be used as a verb, meaning to maintain or add content to a blog.

Certified Component—includes any piece of software that is a component of a total software solution that has been approved for use by an entity such as the USPTO

Certified Font—includes any font that is approved by a central entity such as the patent office for use in an invention disclosure or figures associated with such a disclosure.

Certified Icon—includes any icon that can be used in a figure to be submitted with a patent application to identify a standard component of invention that is approved for it use by a central entity.

Certified Plug-in—includes any software module that can be inserted into a larger software program and used to perform a sub function of the total function of the total system that is approved by a certification party such as the USPTO

Certified Shape—shall include any visual shape that can be used to identify a component in a patent or other drawing that is approved by a central entity such as the patent office for use in a figure associated with an invention disclosure

Certified Template—shall include a group of certified shapes, certified Icons, and or certified fonts that can be used in a figure associated with an invention disclosure and that is approved by a central entity such as the patent office.

Class, in the context of a patent application, —includes a class of patents or other digital documents in an electronic database

Click-through—includes the process of an end user selecting or otherwise activating a hyperlink

Document Map or Map—includes a visual representation of a group of documents or other items or objects, such as patents that shows the relationship of those documents, objects or items to one another. For example, a map might be of a group of documents and their relevancy to each other. Or, a map might include a visual representation.

End User—includes any person or entity, real or virtual that makes use of or otherwise practices any part or all of the disclosed invention and/or any software application or tool disclosed herein or otherwise. End users include, for example, patent applicants, patent examiners, patent attorneys, patent examiner supervisors, document review specialists, diagram or figure design engineers, survey respondents, search tool users, and other persons. In certain embodiments, an end user may be an application, application program interface, reporting or other tool or automated process.

Genetic Algorithm—includes any software application or module that can improve results with use.

Hyperlink or link—includes a set of instructions or code, which may be embedded, or otherwise associated with or connected to, an element, word, object, icon, document, figure, map, file attachment, or other displayed area within a document which, when selected, clicked or otherwise activated by an end user, may cause a computer to perform one or more functions. Examples of functions that might be performed include, but are not limited to, displaying new or additional information, redirecting to a different area of the same or a new document, displaying an advertisement, soliciting and/or capturing information, opening a form that requires end user input, and/or displaying new information that is generally associated with and/or related to the hyperlinked element. New or additional information and/or webpage(s) may or may not be displayed using a separate or new web browser page or popup window or interstitial. Hyperlinks are commonly identified through the use of an underline and/or color coding, e.g., HYPERLINK, but this is not necessarily required or desired. Hyperlinks may be activated by any applicable means, including, but not limited to, left or right clicking on or near the link, placing a pointer on or near the link (briefly, temporarily or not), touching the area, e.g., via use of a touch screen or other pointing mechanism, and/or automatically, e.g., based upon date or time, or other action or inaction of the end user. For example, in some situations, failure to respond within a given timeframe may cause execution or delay of execution of a hyperlink. A hyperlink may be associated with other hyperlinks, e.g., hyperlinks within hyperlinks, documents, programs, words, phrases, or other information or actions. For example, if an end user right clicks on a hyperlink, one or more options may appear, permitting the end user some degree of flexibility in the action or actions taken. The terms link and hyperlink shall have corollary meanings.

Information Disclosure Statement (IDS)—includes the definition provided by the United States Patent and Trademark Office (USPTO).

IDS Report—includes a document that references all prior art material associated with a patent application or invention disclosure

Image—includes figures, pictures, drawings, document images, e.g., document snapshots, etc.

Improvement Module—includes a sub module that is embedded in a total system that is used to improve upon the total system or other sub modules embedded in that system.

Keyword—includes any word or words that are identified as being “of interest.” A keyword may be of interest because it is a word that generally helps to describe the content of the document in which it is used, or for other reasons.

Lexicon—includes a group of words with corresponding definitions. The words in a lexicon may be broken into groupings based on various areas of interest. For example, a lexicon intended to be used with the USPTO patent database may associate word definitions with patent classes and subclasses, so that appropriate definitions can more readily be provided.

Mapping—includes the process of associating documents to one another and providing a visual representation of the relationships of those documents.

Merchant—includes any person that desires to sell a good or service or desires to have one or more end users to review, select, or click a hyperlink in a document and/or receive other information and/or perform other tasks and/or receive information associated with one or more keywords selected by such merchant.

Notes—includes any computer file or data or any free form or other text, graphics, figures and/or any files such as any audio, video, e.g., JPEG or MPEG, pictures, e.g., GIF, or other files, such as, PDF, XLS, XML, TXT, DOC, RTF, or any other known files such as those described on the websites: http://filext.com/ and http://www.computeruser.com/resources/dictionary/filetypes.html, which are incorporated herein by reference. Notes may be attached or associated with any one or more of the following, any electronic element, word or words, phrase, document, figure, hyperlink, webpage, database, table, file, or any other electronic media. Notes may include any description, hyperlink, figure, document or file associated or attached to any of the forgoing and/or any combination of the forgoing. In certain embodiments, notes may contain or refer or reference other notes, e.g., notes within notes. Exemplary methods to provide attachment of notes into documents and/or associate notes with documents, or words, or other data are disclosed in U.S. patent application Ser. No. 11/690,095 “Facilitating Certified Prior Art Note Taking and Method for Using Same,” filed Mar. 22, 2007; (Attorney docket No. 3307102) entitled “Note Overlay System,” filed Apr. 6, 2007; and (Attorney docket No. 3307103) entitled “Document Examiner Comment System,” filed Apr. 6, 2007; each of which is incorporated herein by reference.

Patent Application—includes an invention disclosure that has been filed with a registration entity such as the USPTO

Patent Drafting Engine—includes a software module that can partially or completely draft and/or modify an existing draft patent application and/or file those applications with a registration entity such as the USPTO.

Patent Figure—includes any figure or document attached to a patent application

Patent Section—includes any section of a patent application or invention disclosure such as the background, summary, title, abstract and or claims.

Patentability Score—includes a score assigned by one or more people, e.g., an end user, or computer programs to a patent application that relate to its strength of patentability in categories such as novelty, obviousness, and usefulness.

Plug-in—includes any software application or module or one or more computer instructions, which may or may not be in communication with other software applications or modules, and may include any file, image, graphic, icon, audio, video or any other attachment. Plug-ins may be comprised of any one or more set of computer instructions using any computer programming language.

Relevancy—includes how relevant a word, phrase, patent section, patent figure or document is to another word, phrase, patent section, patent figure or document

Rules—includes computer instructions that can provide application direction and/or decision making and includes both inference and reactive rules. Rules may include permissions, limitations, method steps, alert event conditions, alert contents, workflow instructions, security measures, business process management instructions, if/then/else instructions and/or any supporting data, variables, or computing instructions and/or logic.

Rules Based—includes any system or application or module that uses or relies on one or more rules.

Search Relevancy—includes how relevant sections of a document are to a word, phrase, patent section, patent figure, or document are when producing search results for a query. For example, the abstract of a patent document can have higher search relevancy than the background of a patent document when conducting prior art searches using a prior art search software tool.

Search Weight—shall mean the score that one section of a document has to other sections of a document when conducting searches against a database of documents in which that document is included.

Subclass—includes a subclass of patent documents as defined by the USPTO. Subclass can also include any sub classification of a database of electronic documents.

Synonym—is any word or group of words that have the same or similar meaning of another word or group of words and/or that may be interchangeable. The opposite of synonym is antonym.

Thesaurus—includes an electronic database of words that have been mapped to indicate similarities in word definitions. The thesaurus may be broken into classes and subclasses that relate to the classes and subclasses of documents stored in an electronic database and/or accessed via such database

Virtual—includes anything that is not real, in whole or in part, and/or anything real, in whole or in part; which may be simulated, represented, presented or depicted in a virtual environment, video game or displayed on a screen.

Virtual Environment—any technology that permits one or more end users to interact with a real, imaginary or virtual computer simulated environment.

Virtual World—includes a world created in an online game such as World of Warcraft, or a virtual community such as Second Life, Eve or There.com

Video Game—shall mean any massive multi online player game such as World of Warcraft and any virtual world such as Second Life

Web page—includes any resource, form, or any information that is accessible via the Internet and that is suitable or exists on the world wide web. A web page usually includes information in any applicable format, e.g., HTML or XHTML. Web pages may include hyperlinks or provide other means of navigation to other web pages. Web pages may be accessed by any applicable means, including, but not limited to: any computing or internet enabled devices, e.g., personal computers, laptops, PDAs, cell phones, video game controllers, or any other communications device, which may be local or remote to the computer or server where such web page(s) may exist or reside.

Word—includes one or more groups of letters including titles, indices, text, headings, descriptions, diagrams, etc., and documents (in whole or in part), phrases (i.e., groups of two or more words), synonyms, antonyms, icons, graphics, drawings, schematics, blueprints, pictures, audio and/or video, and/or any combination of the forgoing, The words “Word” and “Words” shall have corollary meanings.

As stated above, according to various embodiments, the present disclosure provides a lexicon tool for use, for example, with a document preparation tool such as a PDT.

In certain embodiments, the lexicon tool may not be limited to providing definitions, synonyms, and antonyms to single words. In this embodiment, the lexicon tool may also include phrases, sentences, complete or partial paragraphs, documents etc. as entries. In such a case, the lexicon tool may be able to offer clarifying language, and alternatives for the phrases, sentences, complete or partial documents, etc. For example, the phrase “in spite of everything else in this document” might be given a “synonym” or alternative entry of “notwithstanding anything herein to the contrary.” Alternatively, an end user who wishes to cite a particular article or book as supporting evidence for a particular statement may be provided, by the lexicon tool, with the latest version of the article or book, or a shepardized list of alternative articles/books.

In a further embodiment, end users can also suggest maps for subsequent approval and/or directly map new words to existing words in the lexicon provided by the patent drafting tool. These words, if or once approved (if necessary) can be mapped to words in the lexicon as synonyms and antonyms. Submitted or proposed map(s) may be approved by any suitable means, including, for example, by: peers of the person(s) submitting such proposed mapping; one or more end users authorized or otherwise tasked with such responsibilities; a formal review process; all or some end users voting or ranking the relevancy or accuracy of such submitted maps. Maps and relevancy scores may be determined by any applicable means, including methods disclosed in U.S. Patent Application Ser. No. ______ (Attorney docket No. 3303104) entitled “Self-Teaching Thesaurus,” filed Apr. 6, 2007

In some embodiments, definitions, including synonyms and/or antonyms, may be imported into the lexicon tool. Importation may be performed by (authorized) end users or automatically. When importing definitions and other information, new information may be immediately mapped and/or made available for use. Alternatively, the new material may require review and/or approval before being mapped and/or made available. Any suitable approval method, including those discussed above may be employed.

According to various embodiments, a review/approval method may include, for example, determining if the word, definition, map, synonym and/or antonym are relevant given the source document and/or related document(s) in question, the section or intent or meaning where such information is to be applied or mapped, the source or trustworthiness of the information, definition, synonym, antonym and/or map and/or any other applicable information or determining means. Accordingly, a manual or automated review processes permits applications and/or (authorized) end users to determine if a proposed definition, synonym, and/or antonym is applicable, relevant, accurate, complete, or otherwise generally useful as imported, submitted and/or mapped.

According to an embodiment, the lexicon tool will associate one or more definitions with each word in a document at the time the document is filed, captured, or recorded. In this fashion, the document is stored along with associated definitions, synonyms, antonyms, and/or other information. The document may then be stored so that it is un-modifiable, modifiable only with authorization, or modifiable only with change tracking. This can speed application development and simultaneously encourage use of commonly defined or accepted terms, which would also simplify the review process and communications by and between all affected or interested parties, such as a patent examiner and a patent attorney or inventor.

According to an embodiment, (authorized) end users can contest the definition of a word, synonym, antonym and/or document and/or map by submitting a request to reexamine a definition, word, antonym, synonym, document or map to the system or the duly authorized individual or parties responsible for mediating such disputes. The request may include the word, synonym, antonym, map, document and/or the problem with the definition or any of the forgoing, and/or the reason for the problem, and suggestions for improving or modifying the definition and/or resolving the problem. For example, the end user may submit a (proposed) revised definition or map.

In another embodiment, (authorized) end users may submit specific definitions, the use of which is to be limited to a particular document. Such one-time or limited use definitions or other information may apply only to the identified use in a particular document and generally may or may not be accepted, mapped, or generally made available to other users of the lexicon tool.

In some embodiments, some or all of the entries in a lexicon tool may have a certified definition, meaning that the definition has been approved by an authoritative agent. It will be understood that many words will have more than one certified definition. For example, one definition for “case” might be “a legal dispute between two or more opposing parties” while another may be “an object that can hold or contain items, such as a suitcase.” In the event that a word having more than one certified definition is used in a particular document, the author or other authorized individual or entity may provide an indication as to which definition is the desired, most desired, applicable, generally applicable, or preferred entry. Such preference may be indicated using any applicable means, including, for example, selection of the preferred word from a list of words provided by the lexicon tool, and/or by ranking each definition in the event that more than one definition may apply, but where multiple definitions may have different applicability. Furthermore, preference may be indicated using percentages or a “slider bar” to indicate weighting and/or by responding to a survey or other questions, and/or by ranking them from most to least applicable, for example, by ranking each from 1 to 10 with 10 being highest.

According to another embodiment, entries in the lexicon could be associated with advertisements. Advertisers may or may not have to pay a fee for this service. For example, the term “CPU” could be associated with an advertisement from Intel for its latest processor. Alternatively, or additionally, the word could be associated with or act as a hyperlink to a wholesale or retailer that sells the latest Intel processor. Each component part of a particular advertiser's products could be advertised in this manner. Accordingly, different manufacturers of similar goods could compete for the right to associate their advertisements with particular words in the lexicon.

In certain embodiments, links to definitions, words, documents, synonyms, antonyms, other information, or data elements may be provided by permitting an end user to click on the definitions, words, documents, synonyms, antonyms, other information, or data elements. Such definitions, words, documents, synonyms, antonyms, other information, or data elements may or may not be imbued with identifying characteristics or marks. For example, an underline or change in font style, color, and/or other unique identifying mark, logo or icon. For example, such word or words may be underlined with the “squiggly” lines generally used in Microsoft Office Word to note misspellings, but such squiggly line may be in blue or another color so as to indicate a meaning other than a misspelling. In addition or in the alternate, such definitions, words, documents, synonyms, antonyms, other information, or data elements may not have any observable identifier until or unless an end user performs some action or step. For example, such identifying marks, fonts, colors, underlining, or other identification means may not be visible until the user: 1) places a cursor or pointer near or over such definitions, words, documents, synonyms, antonyms, other information, or data elements; 2) clicks or right clicks on any such definitions, words, documents, synonyms, antonyms, other information, or data elements; 3) selects an option in a menu that may turn on or off the display of some or all such identifying means, e.g., the user selects from a menu: view, then selects “definitions” or “enable optional hyperlinks” or “enable definitions” etc.; 4) while right clicking on one or more words, selects from a menu of choices that permits the end user to display definitions, synonyms, antonyms or other information, including, optional notes. According to some embodiments, a selection may activate any option or all options that are present and/or enabled (if required).

In certain embodiments, the system may permit an (authorized) end user to establish filters on such definitions, words, documents, synonyms, antonyms, other information, or data elements. For example, an end user may opt to view only those definitions submitted by a known or trusted source, and/or only those that have been reviewed or officially authorized.

In another embodiment, the system may permit hyperlinks, documents and/or notes to be attached to a document and/or any definitions, words, documents, synonyms, antonyms, other information, or data elements, associated with the document. For example, the hyperlinks, documents and/or notes may provide information regarding results of any court cases or other proceedings and/or other reviews wherein such definitions, words, documents, notes, synonyms, antonyms, other information, or data elements have been reviewed or otherwise contested and/or reviewed or discussed by one or more parties and, optionally, the outcome of such cases. Alternatively, the document may include hyperlinks to other data, documents and records or resources, and/or notes relating to such case or proceeding or reviews, e.g., a hyperlink may be provided that is connected to the public records and/or a hyperlink to any news or magazine or journal review articles, e.g., Harvard Business Law Review articles, and/or a link or note regarding one or more of the participants to such a review or case, e.g., the plaintiff and/or the defendant and/or their attorneys, etc. Where multiple documents or hyperlinks exist or are provided, such documents or hyperlinks may be sorted in any applicable order, including, but not limited to: date or relevancy of such cases, documents or notes, and/or based upon a willingness of one of the interested parties to pay for higher priority or to place an advertisement, such as a patent attorney that may be willing or is otherwise seeking additional clients that may or may not be related to or may or may not have an interest in such case or review and/or may have a similar case.

In certain embodiments, definitions and/or such hyperlinks, documents and/or notes and/or advertisements may be submitted and/or attached and/or mapped by using notes or hyperlinks. Exemplary methods to provide attachment of notes into documents and/or associate notes with documents, or words, or other data are disclosed in U.S. patent application Ser. No. 11/690,095 “Facilitating Certified Prior Art Note Taking and Method for Using Same,” filed Mar. 22, 2007; (Attorney docket No. 3307102) entitled “Note Overlay System,” filed Apr. 6, 2007; and ______ (Attorney docket No. 3307103) entitled “Document Examiner Comment System,” filed Apr. 6, 2007; each of which is incorporated herein by reference.

In yet other embodiments, relevancy scores may be determined, in whole or in part, through the use of automated means. In addition to the novel relevancy ranking methods disclosed herein, other methods to determine relevancy between and among documents and/or websites are well known within the prior art, including, for example, the methods discussed in the book entitled “Text Databases and Document Management: Theory and Practice, by Amita Goyal Chin, which is incorporated by reference.

Methods to create web pages, hyperlinks and hypertext are well known in the prior art and any person with ordinary skill in the art can design and create such hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,” “Information Architecture for the World Wide Web: Designing Large-Scale Web Sites [ILLUSTRATED], by Louis Rosenfeld (Author), Peter Morville,” Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence: Wild Computing, Distributed Digital Consciousness, and the Emerging Global Brain (IFSR International Series on Systems Science and Engineering), by Ben Goertzel.” Each of the above-referenced materials is hereby incorporated by reference.

According to another embodiment, images, audio, video and/or notes can be stored with the lexicon definitions. The images, audio, video and/or notes can be embedded in document, e.g., patent figures that are submitted with the document, e.g., a patent application. By linking the image, audio, video and/or notes to a word, it may not be necessary to number the image (or other data, e.g., a note) as a component in the figure. In addition or in the alternate, when linking such information to a word, a number to the image or other data, may be required and/or may be automatically generated. In the case that a number is required or is generated, the next number may be retrieved or determined by any suitable means, for example, by keeping track of each number in a database designed for such purpose and/or by examining the document to find all previous numbers and incrementing such number by one or some other amount.

In certain embodiments, if an end user modifies or submits notes, and/or other information regarding a figure, document or other information that was created by or modified by other end users, such other end users may be notified of any or all such modifications, proposed or pending or approved, and/or notes or alternatives or other information. Such notification may be accomplished by any applicable means, including, for example, using alerts. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

According to another embodiment, the lexicon tool can include standard legal language or boilerplate entries. These entries may also be divided into categories that might aid to provide the correct or a more suitable entry for a given document, based on subject matter, document section, etc. Accordingly, rather than inserting the boilerplate or definitions directly into the patent application, the patent application can be simply linked to the boilerplate and/or definitions in the lexicon. The lexicon tool may be configured to store the linked language and, when a hyperlink is clicked in the patent application, retrieve those pieces of data as they existed at the time the patent application was drafted, filed, modified, etc. The lexicon can also refer to figures in the same manner.

In certain embodiments, end users may choose to periodically update one or more definitions. A system to facilitate such updates may be provided. For example, a patent practitioner may develop an initial and numerous subsequent versions of any given patent disclosure or application. When the initial draft is composed, the practioner may choose to include one or more words or definitions in the draft document. Then, over time, the practitioner may opt to modify the draft and, when making any updates or additions, check to determine if any one or more such words or definitions might have changed in the interim period. If any one or more changes to such words or definitions have occurred, e.g., new synonyms or antonyms have been added, and/or a definition has been modified or expanded, the practitioner may then be presented with an option to either retain the original definition or accept the new definition. In certain embodiments, such choices may be presented to end users via any applicable means, including, but not limited to; 1) a “search and replace” function, where the system may permit the end user to scan through a document to find any such definitions, documents, notes, images, etc., 2) automatically or upon receipt of a request or instruction, highlighting of such definitions, documents, notes, images, etc., 3) automated updating, which may automatically import all revisions to any such words, documents, notes, images, etc., and/or only update those as indicated by an end user and/or any combination of the above. In this fashion, end users can quickly identify where such links or definitions, etc. exist or are used within a given document or documents, and, optionally, update any one or more of such words, documents, notes and images, etc.

In yet another embodiment, the system permits such updating to occur within multiple documents at one time. For example, an end user may be alerted that a change has occurred or has been submitted to one or more words in the lexicon. The end user may be alerted via any applicable means, for example, via email message or popup instant message. In certain embodiments, definitions may be submitted and/or attached and/or mapped by using notes or hyperlinks. In the event that an alert is received or an end user otherwise determines that a change to one or more documents or definitions, etc., has occurred, the end user may first review the change then determine if the change is appropriate or is otherwise desirable. If the change is appropriate or otherwise desirable, the end user may decide to incorporate such modifications into any one or more or all of the end user's existing documents.

In certain cases, such as with a patent application, changes may only be permitted at certain times, steps, phases or other points during the lifecycle of the patent application. For example, the end user or patent applicant or other authorized person may be permitted to freely incorporate any updates or revisions at any time up to the point that the application publishes or is first examined. Thereafter, for example, there may be rules to govern any subsequent updates or changes. For example, prior to incorporating a change after the document has been published, the applicant or other authorized third party, e.g., applicant's patent attorney, may be required to notify, e.g., send an alert, and/or insert the change using “change tracking” features, so that a patent examiner or other third party will be able to trace the history and timing of any such updates or changes.

In certain embodiments, all entries and revisions shall carry a time and date stamp. Time and date stamping and change tracking may be encrypted to prevent unauthorized or fraudulent modifications. In such cases, time and date stamping and change tracking would permit (authorized) end users to determine the various states of any such definitions, notes, images, video, audio, documents, or text, etc., at the time of each such change, update or modification. In this fashion, the priority of ideas, e.g., within a patent application, may be determined. In addition or in the alternate, a copy of the data before and after any such change or update may be stored.

According to another embodiment, the patent lexicon can also compile all the definitions of a word in other patents and allow the end user to select which definition(s) or definition fragments he wants to compile.

The lexicon and drafting tool may include a graphical user interface to simplify interaction with such lexicon database and/or drafting tool, which interface or GUI might permit an (authorized) end users easy access to any one or more of the features disclosed herein.

Methods to design easy to use graphical user interfaces (GUIs) are well known in the prior art. For example, the books entitled “The Essential Guide to User Interface Design,” by Wilbert O. Galitz and “Interface Design: Effective Design of Graphical User Interfaces for the Web and Multimedia Pages,” by Alistair Dabbs both describe how to design and construct a useful GUI, which books are hereby incorporated by reference.

In certain embodiments, end users may desire to search notes, words, documents or databases, for example, a patent database to find relevant notes, words, documents, e.g., patents and/or prior art that may require lexicon updates and/or definitions, synonyms and/or antonyms. Exemplary methods for providing patent and prior art searches are disclosed in U.S. patent application Ser. No. 11/671,380, “Automated Patent Searches” filed Feb. 5, 2007; Ser. No. 11/693,555 “Providing Certified Patent Searches Conducted by Third Party Researchers” filed Mar. 29, 2007; and ______ (Attorney docket No. 3304103) entitled “Enhanced Patent Prior Art Search Engine,” filed Apr. 6, 2007; each of which is hereby incorporated by reference.

In other embodiments, end users may desire to prioritize the processing of their submissions, documents, notes, reviews, commentary or other tasks or items submitted to a queue. In such cases, methods to provide for document prioritization are desirable. Exemplary methods for priority queuing documents are disclosed for example in U.S. patent application Ser. Nos. 11/462,621 11/462,621, “Fee-Based Priority Queuing for Insurance Claim Processing,” filed Aug. 4, 2006; Ser. No. 11/611,024 “System and Method for Prioritizing Items in a Queue” filed Dec. 14, 2006; and PCT Application No. PCT/US506/340347, “Insurance Form Priority Queuing;” each of which are incorporated herein by reference.

In certain embodiments, the disclosed invention may be practiced in the real or virtual world. For example, a video game may include a virtual patent office. Exemplary methods and systems for providing protection of intellectual property in a virtual environment are disclosed, for example, in U.S. patent application Ser. Nos. 11/428,263, “Video Game Environment” filed Jun. 30, 2006; Ser. No. 11/620,563 “Copyright of Digital Works in a Virtual Environment,” filed Jan. 5, 2007; Ser. No. 11/689,977, “Digital Rights Management in a Virtual Environment,” filed Mar. 22, 2007; Ser. No. 11/671,373 “Video Game with Control of Quantities of Raw Materials” filed Feb. 5, 2007; Ser. No. 11/680,960 “System for the Creation and Registration of Ideas and Concepts in a Virtual Environment,” filed Mar. 1, 2007; each of which is incorporated herein by reference.

The disclosed invention may be applied to a virtual environment, world or video game(s) or any combination of the above. For example, advertisements, such as those disclosed herein may be delivered in the virtual world. In such cases, methods to ensure that agreements are enforceable and that advertising fees are collected in such virtual environments are desirable. Exemplary methods for providing such contract enforcement and collection of fees are disclosed, for example, in U.S. patent application Ser. Nos. 11/279,991 “Securing Virtual Contracts with Credit,” filed Apr. 17, 2006; Ser. No. 11/624,662 “Securing Contracts in a Virtual World,” filed Jan. 18, 2007; Ser. No. 11/559158 “Financing Options in a Virtual World” filed Nov. 13, 2006; Ser. No. 11/620,542 “Satisfaction of Financial Obligations in a Virtual Environment Via Virtual and Real World Currency,” filed Jan. 5, 2007; Ser. No. 11/421,025 “Financial Institutions and Instruments in a Virtual Environment,” filed May 30, 2006, and Ser. No. 11/380,489 “Multiple Purchase Options for Virtual Purchases,” filed Apr. 27, 2006; each of which are hereby incorporated herein by reference.

In certain embodiments, before displaying an advertisement and/or before presenting a list of words and/or documents, e.g., from a lexicon of words, it may be desirable to ascertain certain additional information about such advertisement and/or request for information. In such cases, the system may determine that it is necessary, desirable or generally useful to present one or more survey questions to aid in determining which words, documents, or other information should be presented, e.g.,. to help determine which advertisement might yield generally better results, and/or which word or synonym is generally more relevant given the information known about the end user and/or collected by using and/or displaying and/or gathering results from one or more such survey questions. For example, when an end user enters the word “case” into a search tool designed to retrieve a definition of such word or words, the system might ask the end user the following question or questions: e.g., are you an attorney, are you interested in travel, or are you seeking legal advice. Based upon the end user's response, e.g., if the end user responded in the affirmative to the last question, the system might either provide a definition of case to include legal cases, and/or the system may also provide an advertisement for one or more attorneys seeking clients. Based upon the response to one or more questions, the system may present additional qualifying questions, i.e., additional questions to further narrow the search results and or the sort display results. Exemplary methods to provide for survey questions and gathering of data are disclosed by applicants in U.S. patent application Ser. Nos. 60/774,177, entitled “Survey Based Qualification of Keyword Searches,” Ser. No. 11/278,123, also entitled “Survey Based Qualification of Keyword Searches” Ser. No. 11/562,738 “Survey Based Qualification of Keyword Searches” and Ser. No. 11/608,150, entitled “Map and Inventory Based On-Line Purchases” which applications are incorporated herein by this reference.

All embodiments herein which refer to a patent are equally applicable to a patent application, and vice versa, unless explicitly stated otherwise with respect to a particular embodiment. Any reference to a patent (or to a patent application) is solely for reasons of brevity.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

Exemplary programs include:
1. Lexicon Program
2. Patent Drafting Program
3. Billing Program
4. Mapping Program
5. Contest Definition Program

Exemplary database architecture includes:

Word Database (words may be primary words and/or alternative definitions and/or synonyms and/or antonyms each as applicable, which can contain further references as seen below)
1. Word ID
   a. Word Count ID
   b. Word
   c. Word Map ID # 1—N
   d. Document Map ID # 1—N
   e. Document ID—1—N
   f. Word Group ID
      1. Word Class ID
         a. Word Sub-Class ID
      2. Primary Definition
2. Hyperlinks 1—N (e.g., sources/locations of use)
   1. Alternative Definitions 1—N
      a. Definition
      b. Supplied By—ID
      c. Hyperlinks 1—N
3. Synonym ID—1—N
4. Synonym
5. Word ID
6. Relevancy Scores 1—N
7. Primary Score %
8. Alternative Score %'s 1—N
   1. Antonym ID—1—N
      a. Antonym
      b. Word ID
9. Relevancy Scores 1—N
10. Primary Score %
11. Alternative Score %'s 1—N
   1. Notes 1—N
      a. Note ID
      b. Note Short Description
      c. Note Long Description
      d. Narrative Text
      e. Attachment Hyperlinks 1—N
      f. Where Used Hyperlinks 1—N
   2. Figure IDs 1—N
      3. Approval Tracking Data 1—N
      a. Definition ID
      b. Submission Date
      c. Submitted By
      d. Reviewed By
      e. Accepted/Rejection Date
   4. Change Tracking ID 1—N
      a. Change tracking notes 1—N
   5. Notes 1—N

Change Tracking Database
1. Change Tracking ID
2. Word or Document ID 1—N
3. Word or Document Map ID 1—N
4. Change Type (e.g., Add, change, delete)
5. Change Description
6. Date/Time
7. User ID
8. Before Image
9. After Image
10. Relevancy, ranking or score
11. Change tracking notes 1—N

Figure Database
1. Figure ID
2. Figure Description
3. Figure or Attachment
4. Submitted By ID
5. Source ID
6. Editor Application ID
7. Document/Patent Application Where Used ID 1—N
   a. Hyperlinks 1—N
8. Notes 1—N

Document Database
1. Document ID
2. Document Description
3. Document Owner ID
4. Document Map ID # 1—N
5. Hyperlinks (e.g., document locations) 1—N
6. Class 1—N
7. Subclass 1—N
8. Type 1—N
9. Subtype 1—N
10. Date/Time Stamps
   a. Submitted/Found/Indexed On
   b. Submitted/Found/Indexed By ID or Hyperlink
   c. Revised On 1—N
   d. Revised By 1—N
   e. Before Image 1—N
   f. After Image 1—N
11. Attached Notes 1—N

User Database
1. User ID
2. Name
3. Security Profile
4. Field of Use 1—N
5. Financial Information
   a. Billing Method ID
   b. Credit Card Information
      1. Preferred Card Number
      2. Preferred Card Holder
      3. Preferred Card Type
      4. Name
      5. Expiration Date
      6. Security Code
6. Additional Cards 1—N
   a. Card Number
   b. Card Holder (e.g., Bank Name)
   c. Card Type (e.g., Visa)
   d. Name
   e. Expiration Date
   f. Security Code
7. User Mailing/Billing Address

User Rules Database
1. Rule ID 1—N
   a. Word(s)/Documents Applied To 1—N
2. Rule Description
   a. Rules 1—N
   b. Billing Terms and Conditions ID 1—N
3. User Attorney of Record
4. Attorney ID 1—N
5. User Qualifications 1—N
6. Attached Notes 1—N

User Qualifications Database
1. Qualification ID
2. Description
3. Qualification Type
4. Years Experience
5. Fields of Use Applicable 1—N
6. Notes 1—N

Attorney Database
1. Attorney ID
2. Name
3. Security Profile
4. Address
5. Description
6. Qualifications ID 1—N
7. Notes 1—N

Billing Terms and Conditions Database
1. Billing Method ID
2. Billing Type
3. Description
4. Billing Frequency
5. Due by # days
6. Late by # days
7. Interest Rate Fixed
8. Interest Rate Variable
9. Interest Accrues after days
10. Notes 1-N

Accounts Receivable Database
1. User ID
2. Total Amount Owed
3. Transaction Detail Records 1—N
4. Date of Transaction
5. Type
6. Document ID
7. Word ID
8. Hyperlinks 1—N
9. Amount
10. Notes 1—N

Search Database
1. Document ID
2. Document Location/Hyperlink
3. Notes 1—N

Transaction Database
1. Transaction ID
2. Description
3. Date/Time
4. Type
5. User ID
6. User Rules Used 1—N
7. Billing T&C's 1—N
8. Billing Method ID
9. Transaction Amount
10. Results 1—N
   a. Note Added, Changed, Deleted, and/or Accessed
11. Hyperlink Clicked
12. Sub-Hyperlinks Clicked 1—N
   a. Advertisement/Note and/or Webpage) Displayed 1—N
13. Click Through y/n
14. Duration of view
   a. Conversion y/n
   b. Conversion dollar amount
      1. Notes 1—N
15. Notes 1—N

Advertisement Database
1. Advertisement ID
2. Advertiser ID
3. Description
4. Words 1—N
5. Documents 1—N
6. Hyperlinks 1—N
7. Advertising Content File 1—N
8. Notes ID 1—N

Document Class Database
1. Class ID
2. Description
3. Notes 1—N

Document Sub Class Database
1. Subclass ID
2. Description
3. Notes 1—N

Document Type Database
1. Type ID
2. Description
3. Notes 1—N

Document Sub Type Database
1. Subtype ID
2. Description
3. Notes 1—N

Group Database
1. Group ID
2. Description
3. Notes 1—N

Advertisement Type Database
1. Type ID
2. Description
3. Notes 1—N

Word Count Database
1. Word ID
2. Number of Occurrences
3. Hyperlinks 1—N
4. Notes 1—N

Survey Database
1. Survey ID
2. Survey Description
3. Advertiser ID
4. Survey Question ID 1—N
5. Question
6. Answer Options 1—N
7. Notes 1—N

Results Database
1. Result ID
2. End User ID
3. Survey Questions 1—N
4. Survey Answers 1—N
5 . Date/Time Stamp
6. Narrative or Text Responses 1—N
7. Attached Notes 1—N
8. Notes 1—N

Rules Database
1. Rule ID
2. Rule Description
3. Rules 1—N
4. Notes 1—N

Search and Survey Database

Word Descriptor Database

Notes Database
1. Note ID
2. Hyperlinks 1—N
3. Note Description Short
4. Note Description Long
b 5. Note Group ID
6. Note Class ID
7. Note Subclass ID
8. Note and/or Note Attachments 1—N
9. Owner/Submitted By ID
10. Original Submission Date/Time
   a. Notes 1—N
11. Modifications 1—N
12. Owner/Submitted By ID
13. Modification Submission Date
14. Short Description
15. Long Description
16. Owner/Submitted By ID
17. Original Submission Date/Time
18. Hyperlinks 1—N
19. Change Image 1—N
   a. Before Change
   b. After Change
   c. Notes 1—N

Suppression Rules Database

Hyperlink Database
1. Hyperlink ID
2. Hyperlink
3. Description
4. Owner ID
5. Advertiser ID
6. Notes 1—N

User Database
1. User ID
2. Name
3. Account Type
4. Description
5. Terms and Conditions ID
6. Text
7. Notes 1—N

Document Group Database
1. Group ID
2. Description
3. Includes Sub-Groups/Sub-Class IDs 1—n
4. Notes 1—N

Document Class
1. Class ID
2. Description
3. Includes Sub-Class IDs 1—N
4. Notes 1—N

Document Sub Class
1. Subclass ID
2. Description
3. Notes 1—N

Note Class
1. Note Class ID
2. Description
3. Includes Sub-Class IDs 1—N
4. Notes 1—N

Note Subclass
1. Note Subclass ID
2. Description
3. Notes 1—N

Nick Name Database
1. Nick Name ID
2. Nick Name (Short Description)
3. Nick Name (Long Description)
4. Patent or Document Number
5. Notes 1—N

Patent Application or Document ID Database
1. Patent or Document ID #
2. Hyperlinks 1—N (e.g., Link to that patent on different websites)
3. Notes 1—N

Alert Event Rules Database
1. Alert Event Rule ID
2. Alert Event Description
3. Alert Event Rules 1—N
   a. Event Condition
   b. Alert Recipient ID 1—N
      1. Alert Method 1—N
   c. Alert Database ID 1—N
4. Notes 1—N

Alert Database
1. Alert Database ID
2. Alert Contents, one or more of:
   a. Text
   b. Variable Data
   c. Executable
3. Notes 1—N

Alert Methods Database
a. Alert Method ID
b. Method Type
2. Delivery Method (cell phone, pager, e-mail, PDA, database, executable, etc.)
3. Notes 1—N

Alert Recipient Database
1. Alert Recipient ID (e.g., end user ID)
2. Description
3. Alert Method Preferences ID 1—N
4. Notes 1—N

Word Queue Database
1. Queue ID #
2. Queue Position #
3. Word ID
4. Submitted By ID 1—N
5. Examiner ID
6. Attorney ID
7. Date/Time Stamps
   a. Submitted On Date/Time
   b. Expected Review Date
8. Notes 1—N

Examiner Database
1. Examiner ID
2. Name
3. Security Profile
4. Areas of practice/Fields of Use 1—N
5. Contact Information
6. Qualifications 1—N
   a. Current Cases ID 1—N
   b. Prior Cases ID 1—N
7. Notes 1—N

Map Database
1. MapID#
2. Description
3. Notes 1—N
4. Source Document ID #
   a. Source Words ID # 1—N
   b. Map references (sources) ID 1—N
      1. Map references (nodes) ID 1—N
      2. Map references (other) ID 1—N
   c. Related Document or Word ID # 1—N
   d. Type ID (e.g., word or document, etc.)
   e. Related Document or Word ID # 1—N
5. Related Document or Word ID Relevancy Score, %, or Rank
   a. Map references (sources) ID 1—N
   b. Map references (nodes) ID 1—N
   c. Map references (other) ID 1—N
      1. Notes 1—N
6. Notes 1—N

Filed Document Database
a. Document Database ID/Name/Location
b. Document ID # 1—N
c. Submitted by ID # 1—N
d. Examiner ID# 1—N
e. Attorney ID # 1—N
f. Description
g. Notes 1—N
h. Document Image 1—N
i. Date/Time Submitted
j. Lexicon Entries Used Database

2. Lexicon Entries Used ID 1—N

3. Lexicon Images 1—N

4. Filed Document Lexicon
a. Lexicon Database ID/Name/Location
b. Lexicon (e.g., Word or Document or Image) ID # 1—N
c. Submitted by ID # 1—N
d. Examiner ID # 1—N
e. Attorney ID # 1—N
f. Description
g. Notes 1—N
h. Lexicon Image 1—N
i. Date/Time Submitted

5. Notes 1—N

6. Contest Definition Queue
a. Contest Case ID #
b. Queue ID #
c. Queue Position #
d. Submitted by ID # 1—N
e. Examiner ID # 1—N
f. Attorney ID # 1—N
g. Description
h. Word or Documents ID # 1—N
i. Reasons for case
j. Proposed solutions
k. Notes 1—N
l. Date/Time Stamps
1. Submitted on date/time
2. Expected next review date/time

It will be appreciated that the various software and hardware components described above will be configured to perform a variety of functions and methods. Listed below are some exemplary methods that might be performed by the systems as described herein:

Create a word and its definition
1. Receive a request to create a word
2. Output word creation form
3. Receive word, including definition and document class and subclass
4. Store word in lexicon

Refine the definition of a word
1. Receive a request to refine the definition of a word
2. Output definition refinement form
3. Receive definition refinement
4. Store refinement with word and definition

Use a word in the lexicon in a patent application
1. Receive patent application data
2. Receive a request to use the lexicon
3. Output appropriate entries in lexicon based on application data
4. Receive a request to use a word in the lexicon
5. Output word definition
6. Receive refinement/limitation of definition
7. Insert word in application data
8. Hyperlink word to refined/limited definition

Create an advertisement in the Lexicon
1. Receive a request to link an advertisement to a word in the lexicon
2. Output advertisement form
3. Receive advertisement
4. Link advertisement to word in definition

View an advertisement in the Lexicon
1. Output Lexicon records based on end user request
2. Determine if there are relevant advertisements associated with output records
3. Link advertisements to records
4. Display advertisements based on system rules

Retrieve the definition of a word in a patent application from a hyperlink
1. Receive a click on a word in the lexicon
2. Retrieve and Output associated definition of word

Receive Word and Definition and Place in Queue
1. Receive a request to create a word
2. Output word creation form
3. Receive word, including definition and document class and subclass
4. Place word in approval queue

Approve/Certify Word in Queue
1. Receive certifier log in
2. Retrieve and Output word in approval queue
3. Receive approval
4. Place word in lexicon
5. Alert word submitter that word has been accepted

Reject Word In Queue
1. Receive certifier log in
2. Retrieve and Output word in approval queue
3. Receive rejection
4. Notify submitter that word has been rejected

Use Lexicon to assist in drafting new document
1. Receive request to create document
2. Output lexicon
3. Receive document data
4. Receive requests to insert words from lexicon into document
5. Insert words from lexicon into document as requested

Store Lexicon with Filed Application on file Date
1. Receive document filing request
2. Determine words in document associated with lexicon
3. Determine lexicon definitions for words in document associated with Lexicon
4. Store definitions for words with document
5. File document

Contest Definition
1. Receive a request to contest a definition of a word
2. Store request
3. Suspend use of definition

Override Contest of Definition
1. Receive administrator log in
2. Output request to contest a definition
3. Decline request
4. Notify requester that contest was declined
5. Allow use of definition

Approve Contest of Definition

Receive administrator log in

Output request to contest a definition

Approve request

Notify requester and submitter that contest was approved

Disallow use of definition

Output request for a new definition

Or—Event Driven Method Steps:

Initial Database Loading
1. Create/Load Database(s)
2. Import Words, Definitions, Synonyms and Antonyms from existing database sources (as appropriate/e.g., one time, and/or from time-to-time)
3. Update Database(s)

Primary Patent Drafting Tool/Application
1. Load Database(s)
2. Display primary GUI
3. Receive activity indication/request from end user
4. Determine if one or more subroutines should be executed
5. Execute one or more of the following subroutines as applicable/necessary/desired
6. Update database(s)

Security Application
1. Load Database(s)
2. Determine if requested action and/or end user is permitted
3. If not, notify application and/or end user
4. If yes, permit requested step and/or loading of application or other authorized action(s)
5. Update Database(s)

End User Preferences Application
1. Load Databases
2. Present Preferences GUI if required
3. Receive End User Preferences/Feedback/Usage Tracking Information, including:
   a. Filter Criteria or Rules
   b. Sort Criteria or Rules
   c. Relevancy Information
   d. Weighting Factors, Criteria or Rules
   e. Security Preferences
   f. Feedback/Tracking Preferences
   g. Notes
   h. Usage habits/patterns
   i. Display preferences

Opt In/Sign Up Application
1. Load Databases
2. Receiving Indication of new user sign up
3. Record any and all or available information regarding one or more patent applicants and/or applications, end users, examiners, attorneys and/or third parties
4. Update databases

Word Creation/Modification Application
1. Load Database(s)
2. Display Word Entry/Revision GUI
3. Receive input from user to add/modify/delete word and/or associated synonym, antonym and/or primary/alternative definition(s)
4. If applicable
   a. Place word in one or more authorization queues
   b. Receive authorization/certifications as applicable and/or required to accept such add/modify/delete word and/or associated synonym, antonym and/or primary/alternative definition(s)
      1. If applicable, receive relevancy score(s) and/or mapping information
5. Update Database(s)

Word Use/Insertion
1. Load Database(s)
2. Receive one or more requests to search or display one or more words, synonyms, antonyms and/or figures and/or maps
3. Retrieve relevant words, synonyms, antonyms and/or figures or maps
4. Display search/lookup results and, if applicable, other relevant materials
5. Permit user to copy/paste or insert any one or more such words, synonyms, antonyms and/or figures into one or more patent applications or other document(s)
6. Permit end user to submit additions/changes or modifications to such words, synonyms, antonyms and/or figures as applicable
7. Update Database(s)

Advertisement Creation Application
1. Load Database(s)
2. Display advertising creation/modification GUI
3. Receive request to add/change/delete one or more advertisements
4. Receive advertisement hyperlink contents and associate with one or more words, synonyms, antonyms and/or figures and/or documents
5. Determine if such one or more words, synonyms, antonyms, figures and/or documents have pre-existing hyperlinks by current or third party end user or otherwise
6. If not, determine price to associate hyperlink as applicable
7. If one or more similar hyperlinks already exist, execute hyperlink bid pricing application
8. If approved and priced, insert or otherwise associate said hyperlink with said one or more words, synonyms, antonyms, figures and/or documents.
9. Update Database(s)

Hyperlink Pricing Program
1. Load Database(s)
2. Receive pricing request
3. Determine if more than one user wishes a hyperlink to the same or similar word(s), synonym(s), antonym(s), figure(s) and/or documents
4. Determine pricing and/or auction hyperlink, or, if applicable, position in list of two or more hyperlinks
5. Notify affected parties, e.g., via an alert
6. Receive indication from one or more users as to willingness to pay and price points
7. Continue process until pricing is determined
8. Receive authorizing for final pricing from affected parties, including end users
9. Update Database(s)

Advertisement Viewing/Use Application
1. Load Database(s)
2. Receive request to display or access advertisement, e.g., user clicks hyperlink or right clicks word
3. Determine if additional browser page or popup or other display method is to be used
4. Display Advertisement, e.g., load and display attached movie file
5. Determine if survey should be presented
6. Present survey
7. Determine if secondary or different advertisement is to be displayed
8. Display advertisement
9. Collect usage information, e.g., impressions for billing purposes
10. Update Database(s)

Word Definition/Synonym/Antonym/Figure/Document Lookup Tool
1. Load Database(s)
2. Receive request from drafting or third party display tool for word, definition, synonym, antonym, figure and/or document display (any one or any combination or all of the forgoing)
3. Determine relevancy information
4. Retrieve requested information, using relevancy information if applicable/available
5. Determine if additional browser page or popup or other display method is to be used (e.g., interstitial popup window)
6. Determine if application and/or end user has requested filter and/or sort and/or relevancy options
7. Display Requested Information (using filter, sort and/or relevancy information and/or filter criteria if applicable// available)
8. Update Database(s)

Document Submission/Filing Application
1. Load Database(s)
2. Receive request to submit document with words, synonyms, antonyms, figures and/or related documents to database, repository or processing agency, e.g., USPTO
3. Capture image of all relevant materials, including then current definitions, along with Time/Date stamp information
4. If desired, encrypt any or all output materials, e.g., patent application, definitions, words, synonyms, antonyms, figures and/or related documents and/or supporting materials to prevent or otherwise control subsequent access and/or modifications
5. Update Database(s)

Mapping Program
1. Load Databases
2. Receive indication that one or more words, synonyms, antonyms and/or documents have been added or changed or removed from one or more databases
3. Receive or determine relevancy information
4. Determine mapping relationships among the forgoing
5. Monitor word, synonym, antonym, document and/or mapping usage
6. Receive feedback from end users and/or determine change in mapping relationships and/or relevancy
7. If desired or required, submit any such changes for review/approval
8. If approved, update mapping relationship data accordingly
9. Update Databases

End User Contest Application
1. Load Database(s)
2. Receive Indication that one or more end users and/or third parties, e.g., patent examiner, contests one or more word definitions, words, synonyms, antonyms, figures and/or other documents and/or supporting materials
3. Determine relevancy/validity of the contest by any one or all of the following if desired/applicable
4. Solicit other end user/third party votes/scores/ranking
5. Use GA
6. Submission to authorized end user or third party
7. Preponderance of feedback
8. If contest is determined valid, accept requested changes
9. Otherwise reject requested changes
10. Update Database(s)

Billing Program
1. Load Database(s)
2. Receive indication that billing activity has occurred
3. Determine affected parties, e.g., payer and payee
4. Determine billing rules, terms and conditions
5. Determine billing amounts due
6. Create Invoice and A/P or A/R notices/entries
7. Send Invoices and notices
8. Update Databases
9. Await Payment
10. Receive payment indication
11. Apply payments
12. Notify A/P or A/R systems/and/or affected parties
13. Determine if payments are timely/sufficient
14. If not, execute collections program
15. Update Database(s)

Collections Program
1. Receive indication payments are late and/or insufficient
2. Load Database(s)
3. If applicable, execute one or more of the following steps:
4. Send late notice
5. Send insufficient payment or funds notice
6. Limit or prevent further use until payment terms are partially or fully satisfied, each according to billing terms and conditions and/or rules
7. Collect funds due from primary and/or secondary credit cards on file.
8. Notify affected parties
9. Update Database(s)

Alerts Program
1. Load Database(s)
2. Determine if Alert Event has occurred
3. Determine Alert Contents based upon alert rules
4. Determine Alert Recipients and Contents and Delivery Method(s)
5. Send Alert(s)

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device / article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
receiving an electronic version of a document drafted by an author;
identifying a term in the document;
presenting the author with a list of possible definitions for the term;
receiving a definition selection for the term from the author;
associating the selected definition with the term; and
storing the approved definition for the term with the document.

2. The method of claim 1 wherein the document is a patent application.

3. The method of claim 1 wherein receiving a definition selection from the term from the author comprises providing a user interface configured to present a user-selectable list of suggested definitions for the term.

4. The method of claim 3 wherein the user interface is further configured to enable the author to submit his or her own definition for the term.

5. The method of claim 4 wherein the term is a word.

6. The method of claim 4 wherein the term is a phrase.

7. A method comprising:
providing a lexicon tool including:
a database comprising:
a plurality of words;
at least one definition for each of the words; and
a subject matter identifier associated with each definition;
a user interface configured to display term definitions to an end user receiving a document from an end user;
determining the subject matter of the document;
identifying a term in the document;
identifying possible definitions for the term by:
identifying the term in the database; and
comparing the subject matter identifiers for each definition for the term with the subject matter of the document; and
providing to the user a list of possible definitions for the term, wherein presentation of definitions is affected by the subject matter of the document and the subject matter identifiers associated with the definitions.

8. The method of claim 7 wherein the document is a patent application.

9. The method of claim 8 wherein the subject matter identifiers are classes as defined by a patent examining authority.

10. The method of claim 7 wherein a definition is only presented to the end user if the subject matter of the document matches the subject matter identifier of the definition.

11. The method of claim 7 wherein the all the definitions in the database for a term are presented to the user.

12. The method of claim 11 wherein the definitions are presented in a given order.

13. The method of claim 12 wherein the order is determined by which definition subject matter identifier most closely matches the subject matter of the document.

14. The method of claim 7 wherein the term is a word.

15. The method of claim 7 wherein the term is a phrase.

16. A lexicon tool comprising:
a database comprising:
a plurality of words;
at least one definition for each word;
a subject matter identifier for each definition, wherein the subject matter identifier determines the order in which multiple definitions for the same word will be presented to an end user based on comparing the subject matter of a document identified by the end user with the subject matter identifier; and
a user interface; wherein the user interface is configured to provide to an end user definitions for words that are used in a document.

17. The lexicon tool of claim 16 wherein the user interface is further configured to receive definitions from the end user for words that appear in the document identified by the end user.

18. The lexicon tool of claim 17 further comprising a definition certification module configured to obtain approval for the definition received from the end user.

19. The lexicon tool of claim 18 wherein approval is obtained from an entity other than the end user.

20. The lexicon tool of claim 18 wherein upon receiving approval, the definition received from the end user is added to the database.
